(19) United States
(12) Patent Application Publication
(10) Pub. No.: US 2009/0096347 A1
(43) Pub. Date: Apr. 16, 2009

(54) LED Flat Light and A Manufacturing Method Thereof

(76) Inventor: Chao-Feng XU, Dongguan City (CN)

Correspondence Address: Dr. BANGER SHIA, 102 Lindencrest Ct., Sugar Land, TX, 77479-5201, US

(21) Appl. No.: 11/870,996

(22) Filed: Oct. 11, 2007

(51) Int. Cl. H05B 33/00; H01J 9/00

(52) U.S. Cl. 313/498; 445/23

(57) ABSTRACT

An LED flat light and a manufacturing method thereof including processes of preparing a substrate, mounting a support, dispensing an under-fill, mounting an LED chip, wire bonding, dispensing fluorescent powder, and LED packaging; and the finished product of LED flat light includes a substrate provided with multiple insertion holes, each hole being disposed to its peripheral a positive golden finger and a negative golden finger; multiple LED modules electrically connected to one another for each module corresponding to one insertion hole; the insertion hole includes a support comprised of a base and a base cup with the base cup placed in the insertion hole; an LED chip being fixed in the base cup; and both positive and negative electrodes of the LED chip being electrically connected to their corresponding golden fingers on the substrate; the LED chip being covered up with a fluorescent powder layer, where in turn being covered up with a sealing layer to allow firm combination among member of the LED flat light, easy and convenient process for production by lot, and longer service life without affecting optical effects of LED modules when molded in the LED flat light.

### BACKGROUND OF THE INVENTION

(a) Field of the Invention

The present invention is related to an LED optical electronic technology, and more particularly, to an LED flat lighting and a manufacturing method thereof.

(b) Description of the Prior Art

Light emitting diode known for its advantages of longer service life, higher optical effects, and low power consumption has been comprehensively applied in the lighting business. Today, as the scientific technology fast advances, the trade tends to be flattened for further justified application of LED, e.g., an LED flat lighting lamp disclosed in PRC Patent No. 200510034909.X and an LED lighting module as disclosed in PRC Patent ZL200620059140.7.

In the development of LED flat lighting, how to properly distribute LED on a substrate while allowing stable LED lighting without affecting LED optical effects present new challenge for the trade.

### SUMMARY OF THE INVENTION

The primary purpose of the present invention is to provide an LED flat lighting that allows easy process and reliable lighting performance without affecting LED optical effects and a manufacturing method thereof.

To achieve the purpose, an LED flat lighting manufacturing method involves the following steps:

1. Producing substrate: multiple insertion holes are provided on a substrate with each insertion hole disposed on its peripheral one positive golden finger and one negative golden finger;

2. Installing support: a support in as structure provide with a base cup is vertically placed in each insertion hole on the substrate with a base of the support tightly holding against a bottom of the substrate;

3. Dispensing under-fill: a prepared under-fill in proper amount is dispensed into the base cup of each support;

4. Installing LED chip: place an LED chip on the under-fill in each base cup of the support before having the substrate baked in an oven for the under-fill to be fully solidified thus to secure the LED chip in place;

5. Bonding wire: use conductive wire to bond both positive and negative electrodes of the LED chip to their corresponding golden fingers of positive and negative electrodes disposed on the peripheral of each insertion hole on the substrate;

6. Dispensing fluorescent powder: mix the fluorescent powder and adhesive solution and a proper amount of the fluorescent powder solution is dispensed into the base cup of the substrate already bonded with wire by having the fluorescent powder solution to fully cover up the LED chip before being delivered into the oven for baking to solidified the fluorescent powder solution; and

7. LED packaging: drop prepared epoxy resin consistently into each base cup of the support to fully cover up the conductive wire before being delivered into the oven for baking to come up with the LED plate.

A clearing and baking process may be further added between Steps 2 and 3. Wherein, the substrate already mounted with the support in Step 2 is exposed to ultrasonic wave containing detergent for cleaning five up to ten minutes under normal temperature before being delivered into 60˜80° C. oven for baking 20 up to 40 minutes.

Another process of dispensing silver paste is further added into where between Steps 5 and 6. Wherein upon completing the wire bonding process, a proper amount of prepared silver paste is dispensed to where the golden finger is bonded before being delivered into 140˜160° C. oven for baking 50 up to 70 minutes to fully solidify the silver paste for securing the bonded wire in place.

The oven temperature is set within a range of 120˜150° C. for baking 7 up to 9 hours in Step 7.

Multiple pads are disposed on the substrate in Step 1.

The LED flat lighting including a substrate provided with multiple insertion holes with each disposed on its peripheral a positive golden finger and a negative gold finger; multiple LED modules electrically connected to one another with each LED module corresponding to an insertion hole and containing a support comprised of a base and a base cup with the base cup placed in the insertion hole; an LED fixed in the base cup, both positive and negative electrodes of the LED chip and their corresponding golden fingers of positive and the negative electrodes disposed on the peripheral of the insertion hole being electrically connected by means of conductive wire; the LED chip being covered up with a layer of fluorescent powder; and a sealing layer covering up the layer of fluorescent powder to fully cover up the conductive wire.

A pad is disposed on the substrate and the substrate is made either in a circular or a square form. The sealing layer is related to epoxy resin.

Accordingly, the use of the manufacturing method of the present invention allows secured combination among all members including substrate, support, LED chip, fluorescent powder layer, and epoxy resin layer, easy and convenient process for production and longer service life without affecting optical effects of LED modules molded in the resulted LED flat light.

### BRIEF DESCRIPTION OF THE DRAWINGS

FIG. 1 is a schematic view showing an appearance of an LED flat light of the present invention.

FIG. 2 is a sectional view of the LED flat light of the present invention.

FIG. 3 is a schematic view showing a substrate in the LED flat light of the present invention.

FIG. 4 is a magnified view of a support in the LED flat light of the present invention.

FIG. 5 is a schematic view showing a process flow path for manufacturing the LED flat light of the present invention.

FIG. 6 is a first summary schematic view showing a circuit of the present invention.

FIG. 7 is a second summary schematic view showing a circuit of the present invention.

FIG. 8 is a third summary schematic view showing a circuit of the present invention.

FIG. 9 is a fourth summary schematic view showing a circuit of the present invention.

### DETAILED DESCRIPTION OF THE PREFERRED EMBODIMENTS

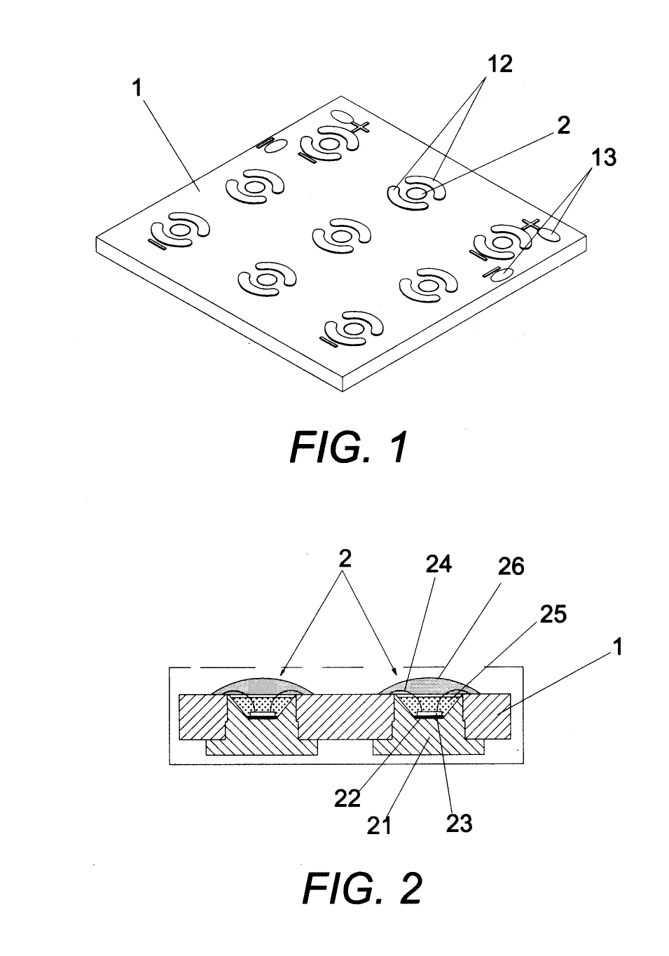

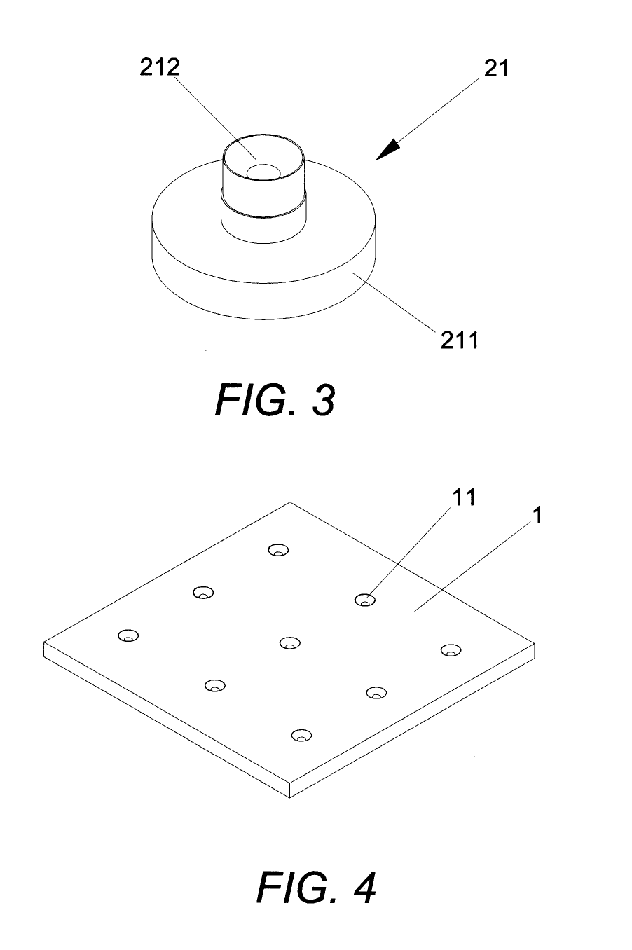

Referring to FIGS. 1, 2, 3, and 4, an LED flat light of the present invention is comprised of a substrate 1 and multiple LED modules 2 electrically connected to one another.

The substrate 1 indicates a square structure and may be made in a circular form; multiple insertion holes 11 are disposed on the substrate 1; a positive golden finger and a negative golden finger 12 are disposed to the peripheral of each insertion 11; and a pad 13 is disposed on the substrate to facilitate subsequent test and inspection operations.

Each LED module 2 corresponding to an insertion hole 11 is comprised of a support 21 including a base 211 and a base cup 212 with the base cup 212 placed in the insertion hole 11; an LED chip 23 is bonded to the base cup through a layer of under-fill bonding 22; both of the positive and negative electrodes of the LED chip are electrically connected to their corresponding golden fingers of positive and negative electrodes disposed to the peripheral of the insertion hole 11 by means of a conductive wire 24; the LED chip 23 is covered up with a fluorescent powder layer 25; the fluorescent powder layer 25 is covered up with a sealing layer 26 to fully cover up the conductive wire 24; and the sealing layer 26 is related to an epoxy resin layer.

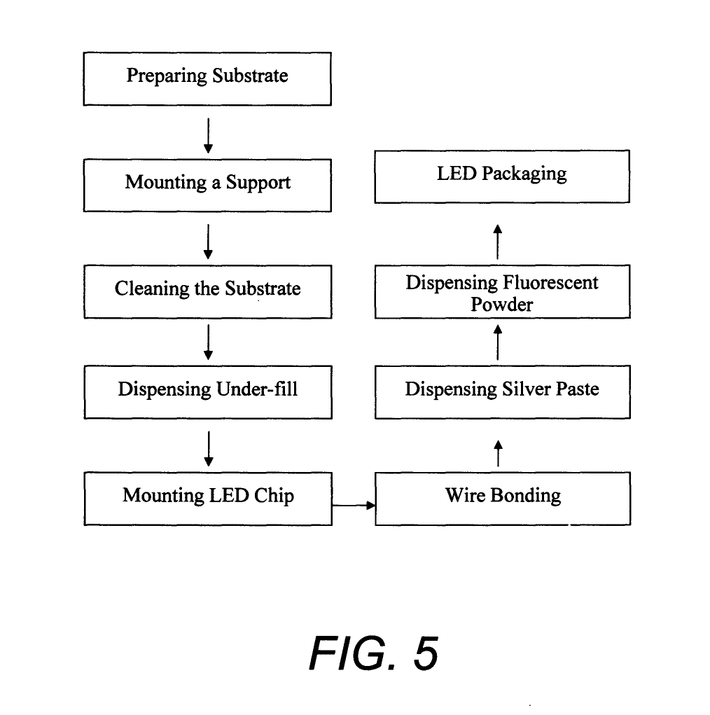

Now referring to FIG. 5, a method for manufacturing the LED flat light is comprised of the following steps:

(1) Producing the substrate 1: multiple insertion holes 11 are provided on the substrate 1 with each insertion hole 11 disposed on its peripheral one positive golden finger and one negative golden finger 12; a pad 13 is disposed on the substrate 11; and the substrate 1 is tested upon completing the mounting;

(2) Installing the support 21: the support 21 provide with a base cup 212 is vertically placed in each insertion hole 11 on the substrate 1 with the base 211 of the support 21 tightly holding against a bottom of the substrate;

(3) Cleaning the substrate 1: the substrate 1 mounted with the support 21 is exposed to ultrasonic wave containing a detergent to clean for 5 up to 10 minutes before being delivered into a 60˜80° C. oven for baking 20 up to 40 minutes;

(4) Dispensing under-fill: a prepared under-fill in proper amount is dispensed into the base cup of each support to form a under-fill bonding layer 22;

(5) Installing the LED chip 23: place the LED chip 23 on the under-fill bonding layer 22 in each base cup 212 of the support 21 before having the substrate baked in an oven for the under-fill to be fully solidified thus to secure the LED chip 23 in place;

(6) Bonding wire: use the conductive wire 24 to bond both positive and negative electrodes of the LED chip 23 to their corresponding golden fingers 12 of positive and negative electrodes disposed on the peripheral of each insertion hole on the substrate; followed with a functional test and inspection by having a positive electrode of from a DC source connected to a positive pad and a negative electrode from the DC source connected to a negative pad to test whether all LED chips are consistently lighted up;

(7) Dispensing silver paste and baking: upon completing the wire bonding, a proper amount of prepared silver paste is dispensed to where the golden finger is wire bonded before being delivered into the 140˜160° C. oven for baking 50 up to 70 minutes to fully solidify the silver paste to secure the bonded wire;

(8) Dispensing fluorescent powder: mix the fluorescent powder and adhesive solution and a proper amount of the fluorescent powder solution is dispensed into the base cup of the substrate already bonded with wire by having the fluorescent powder solution to fully cover up the LED chip 23 before being delivered into the oven for baking to solidify the fluorescent powder into a fluorescent powder layer 25; and followed with inspection of color difference by having the positive electrode from the DC source connected to the positive pad and the negative electrode form the DC source connected to the negative pad to check for consistent color difference when all LEDs are lighted up; and

(9) LED packaging: consistently drop a prepared epoxy resin into each base cup of the support to fully cover up the conductive wire before being delivered into the 120˜150° C. oven for baking 7 up to 9 hours to form the sealing layer and the manufacturing of the LED flat light is completed; and an aging test is then conducted for the finished product by having the LED plate lighted for 24 hours using correct connection means to check for normal function of the LED flat light.

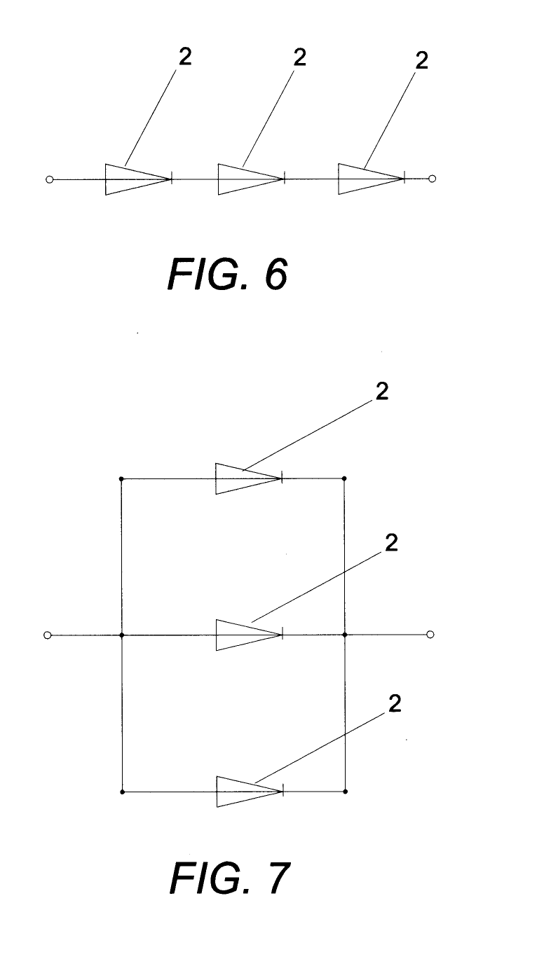

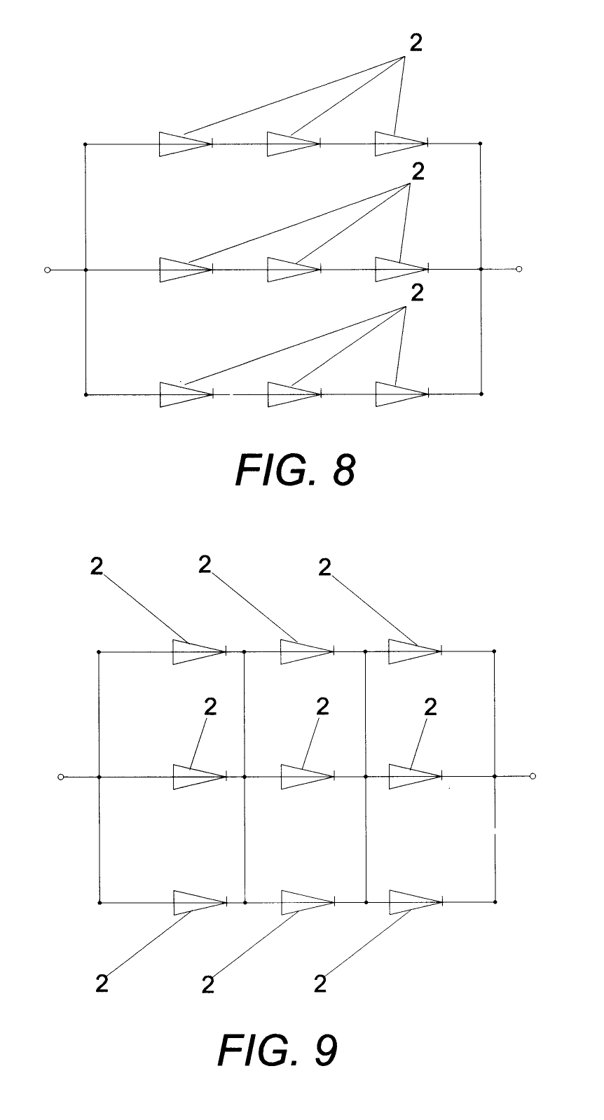

As illustrated in FIGS. 6 through 9 respectively showing four different circuit connections among LED modules on the LED flat light, FIG. 6 shows a straight series connection for those LED modules 2; FIG. 7, straight parallel connection; FIG. 8, series connection among multiple LED modules first before parallel connection among LED modules having identical circuit connected in series; and FIG. 9, parallel connection among multiple LED modules first before series connection among LED modules having identical circuit connected in parallel. Naturally, there are many other possible connections other than those four connections as illustrated in FIGS. 6 through 9.

The present invention allows multiple members including substrate, support, LED chips, fluorescent powder layer, and epoxy resin sealing layer to be firmly combined in easy and convenient process for production by lot, longer service life of the LED flat light without affecting the optical effects of LED modules molded in the LED flat light.

However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim,

1. An LED flat light manufacturing method comprising the following steps:
(1) Producing substrate: multiple insertion holes are provided on a substrate with each insertion hole disposed on its peripheral one positive golden finger and one negative golden finger;
(2) Installing support: a support in as structure provide with a base cup is vertically placed in each insertion hole on the substrate with a base of the support tightly holding against a bottom of the substrate;
(3) Dispensing under-fill: a prepared under-fill in proper amount is dispensed into the base cup of each support;
(4) Installing LED chip: place an LED chip on the under-fill in each base cup of the support before having the substrate baked in an oven for the under-fill to be fully solidified thus to secure the LED chip in place;
(5) Bonding wire: use conductive wire to bond both positive and negative electrodes of the LED chip to their corresponding golden fingers of positive and negative electrodes disposed on the peripheral of each insertion hole on the substrate;
(6) Dispensing fluorescent powder: mix the fluorescent powder and adhesive solution and a proper amount of the fluorescent powder solution is dispensed into the base cup of the substrate already bonded with wire by having the fluorescent powder solution to fully cover up the LED chip before being delivered into the oven for baking to solidified the fluorescent powder solution; and
(7) LED packaging: drop prepared epoxy resin consistently into each base cup of the support to fully cover up the conductive wire before being delivered into the oven for baking to come up with the LED plate.

2. The LED flat light manufacturing method as claimed in claim 1, wherein a cleaning and baking process is added into where between Steps 2 and 3 by having the substrate already mounted with the support in Step 2 to be exposed to ultrasonic wave containing a detergent for cleaning 8 up to 10 minutes at normal temperature before being delivered into a 60˜80× oven for baking 20 up to 40 minutes.

3. The LED flat light manufacturing method as claimed in claim 1, wherein a dispense of silver paste and baking process is further added to where between Steps (5) and (6); upon completing the wire bonding process a proper amount of prepared silver paste is dispensed to where the golden finger is wire bonded before being delivered into a 140˜160× oven for baking 50 up to 70 minutes to fully solidify the sliver paste to secure the bonded wire.

4. The LED flat light manufacturing method as claimed in claim 1, wherein the temperature of the oven in Step 7 is set within a range of 120˜150× for baking 7 up to 9 hours.

5. The LED flat light manufacturing method as claimed in claim 1, wherein multiple pads are disposed on the substrate in Step (1).

6. An LED flat light produced using any manufacturing method as claimed in claim 1 comprising a substrate provided with multiple insertion holes with each disposed on its peripheral a positive golden finger and a negative gold finger; multiple LED modules electrically connected to one another with each LED module corresponding to an insertion hole and containing a support comprised of a base and a base cup with the base cup placed in the insertion hole; an LED fixed in the base cup, both positive and negative electrodes of the LED chip and their corresponding golden fingers of positive and the negative electrodes disposed on the peripheral of the insertion hole being electrically connected by means of conductive wire; the LED chip being covered up with a layer of fluorescent powder; and a sealing layer covering up the layer of fluorescent powder to fully cover up the conductive wire.

7. The LED flat light as claimed in claim 6, wherein a pad is disposed on the substrate.

8. The LED flat light as claimed in claim 6, wherein the substrate indicates a circular or a square form.

9. The LED flat light as claimed in claim 6, wherein a under-fill bonding layer is provided at where between the LED chip and the base cup.

10. The LED flat light as claimed in claim 6, wherein the sealing layer is related to an epoxy resin layer.
